(19) United States
(12) Patent Application Publication
(10) Pub. No.: US 2008/0098454 A1
(43) Pub. Date: Apr. 24, 2008

(54) Network Management Appliance

(76) Inventor: Soon Seah Toh, Singapore (SG)

Correspondence Address: BROOKS KUSHMAN P.C., 1000 TOWN CENTER, TWENTY-SECOND FLOOR, SOUTHFIELD, MI, 48075, US

(21) Appl. No.: 11/718,373

(22) PCT Filed: Oct. 27, 2005
(86) PCT No.: PCT/SG05/00373

§ 371 Date: Jun. 23, 2007

(30) Foreign Application Priority Data
Nov. 2, 2004 (SG) 200406951-4

(51) Int. Cl. G06F 17/00; G06F 15/163; G06F 21/00

(52) U.S. Cl. 726/1; 709/223

(57) ABSTRACT

A network management appliance comprising a central bus element; a plurality of network management modules each coupled to the central bus element; a server element coupled to the central bus element a network interface for interfacing the central bus element with a network to be managed; and wherein network management functions executed by the network management modules are remotely accessible through the server element via the network interface.

### FIELD OF INVENTION

The present invention relates broadly to a network management appliance, to a method for managing a network, and to a computer readable data storage medium having stored thereon computer code means for instructing a computer to execute a method for managing a network.

### BACKGROUND

Businesses are leveraging information technology to gain and maintain a competitive edge, while efficient support of the IT infrastructure poses a real challenge. The IT infrastructure managers of today are facing increasing demands to deliver new systems, services and applications, while the deployment of each new technology is adding to the complexity of the enterprise support model.

Traditionally, network management are software-only solutions, requiring complex installation and configuration procedures before it can be up and running, to manage the network devices in an IP (Internet Protocol) network. These may include network routers/switches, firewalls, servers and applications. In additional, end-users usually need to acquire dedicated server and client machines to host and use the network management software. This consequently results in high complexities and high costs for a typical network management solution deployment.

To effectively manage the IT infrastructure, enterprises require a support model managing the network, systems, services and applications. The complexity of the enterprise support model has manifested itself as the prime concern of the IT managers. The IT infrastructure managers realize the burgeoning need of a simple approach to the complex enterprise management solution involving quick-to-deploy tools that provide real and immediate acceleration towards to the business goals.

The infusion and proliferation of new technology must be supported by an integrated reliable management tools to achieve desirable business benefits, control costs and ultimately avoid IT failures. The management tools are needed not only to understand and monitor various technologies but also effectively implement these technologies to achieve business goals.

The management tools would help the managers to view the entire IT infrastructure as an integrated whole and make useful information for infrastructure management readily available across the enterprise. The tool set for IT managers would typically provide for continuous and real-time monitoring of systems, services and applications, report generation on the health of the infrastructure, flexibility to add new services and technologies, notification of service level or device faults, initiation of problem resolution, knowledge-base to advice on problems, identification of root cause as well as workforce co-ordination and problem assignment.

The above mentioned tool sets would value-add to their service delivery to reduce costs, improve systems, applications, services, databases and network availability, continuously improve on quality and business process, sharpens competitive edge, while providing access to advanced technologies and achieve best-in-class standards.

End-to-end management across multiple components in a distributed heterogeneous environment has also emerged as a requirement in infrastructure management. It is no longer viable to manage individual systems, computers, subnets and networks services in isolation. These components inter-operate to provide connectivity and services. The customer oriented point of view goes through the boundaries of network, services, applications and their performance and service levels. The management tools must provide for end-to-end management across the different management layers.

An end-to-end management solution provides a strategic solution, covering management of all critical components of all services, simplifies and improves setup, deployment, monitoring and measuring of services for faster ROI. End-to-end management also allows the management of enterprise services based on business priorities as well as the maximisation of service availability, keeping services fully operational on 24×7×357 basis to satisfy customers and protect revenue. The end-to-end management solution is also able to keep service delivery costs under control.

The current generation of enterprise management solutions can be broadly classified into two categories. The first category is the central server based management with autonomous agents where there is high scalability but the cost is higher. Upgrades are performed on the central server. These upgrades can be expensive hardware/server and software upgrades. The second category is the usage of thick agents that are resource intensive agents. These agents have limited scalability and lower cost as compared to the central server based management system. Any required upgrades are carried out individually on each agent.

Thus, there is a need for an appliance oriented enterprise management solution that offers central server based management where the cost per agent is driven down to a level that is comparable to that of thick clients while maintaining the advantage of central server based management. The central server provides completely web-based secure and integrated management anytime from anywhere.

Hence, it is with the knowledge of the above concerns and restrictions that the present invention has been made.

### SUMMARY

In accordance with one aspect of the present invention, there is provided a network management appliance comprising, a central bus element, a plurality of network management modules each coupled to the central bus element, a server element coupled to the central bus element, a network interface for interfacing the central bus element with a network to be managed, and wherein network management functions executed by the network management modules are remotely accessible through the server element via the network interface.

The network management appliance may further comprise, a standard event format supported and operable on the central bus element for integrating the plurality of network management modules with the standard event format, and wherein the standard event format enables the plurality of network management modules to communicate with one another.

The network management modules may comprise two or more of a group consisting of, a configuration utility module, an auto-discovery process module, an alarm correlation engine module, a role-based security utility module, a module consisting of data monitors and collectors, a Service Level Agreement (SLA) management processes module, an inventory management utility module, a notification engine module, an automatic-actions on alarms utility module, and a management tasks automation utility module.

The configuration utility module may be used for consolidating and configuring parameters for the network to be managed.

The network management appliance may further comprise, a set of alarm correlation rules in the alarm correlation engine module, and wherein the alarm correlation engine is used for managing alarms from the network to be managed with the set of alarm correlation rules.

The role-based security utility module may provide a centralised allocation of access and domain rights to network users based on their roles as recorded in an access system implemented in the role-based security utility module.

The network management appliance may further comprise, criteria for thresholds of service levels implemented in the Service Level Agreement (SLA) management processes module, and wherein the Service Level Agreement (SLA) management processes module compares performance data against the criteria for thresholds of service levels and decides on the next course of action.

The network management appliance may further comprise, an user database query utility implemented in the inventory management utility module, and wherein the user database query utility is used to retrieve inventory information of the network to be managed from the inventory management utility module.

The notification engine module may send out notifications based on a set of notification rules implemented in the notification engine module.

The network management appliance may further comprise, a filtering criteria implemented in the automatic-actions on alarms utility module, and wherein the automatic-actions on alarms utility module executes automatic actions based on matching alarm events provided by the alarm correlation engine module to the filtering criteria.

The network management appliance may further comprise, a central data repository, and wherein management data associated with the network management functions executed by the network management modules is stored in the central data repository.

The server element may comprise a web server.

The network management modules may be remotely accessible by utilising one or more of a group consisting, an object-modelling capability, an agent-based technology, an applet based technology, and a scripting engine.

The network management appliance may further comprise, a plurality of performance counters, a plurality of transient performance counters, a file system for temporary storing of storing of performance data in a memory, and wherein output from the plurality of performance counters are stored as performance data in the or a central data repository, and output from the plurality of transient performance counters are not stored in the central data repository.

The performance data may be stored into the central depository periodically.

In accordance with another aspect of the present invention, there is provided a method comprising providing a central bus element; coupling a plurality of network management modules to the central bus element; coupling a server element to the central bus element; providing a network interface for the central bus element to be interfaced with a network to be managed; and wherein network management functions executed by the network management modules are remotely accessed through the server element via the network interface.

In accordance with yet another aspect of the present invention, there is provided a computer readable data storage medium having stored thereon computer code means for instructing a computer to execute a method for managing a network, the method comprising providing a central bus element; coupling a plurality of network management modules to the central bus element; coupling a server element to the central bus element; providing a network interface for the central bus element to be interfaced with a network to be managed; and wherein network management functions executed by the network management modules are remotely accessed through the server element via the network interface.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 is a schematic illustration for an architecture used for software modules in an example embodiment.

FIG. 2 is a block diagram showing the hierarchy structures in object modelling in an example embodiment.

FIG. 3 is a diagram illustrating a Central Repository in an example embodiment.

FIG. 4 is an illustration for agent-based communications in an example embodiment.

FIG. 5 is an illustration of a role-based security system in an example embodiment.

FIG. 6 shows information collections and monitoring from a wide range of sources in an example embodiment.

FIG. 7(a) shows different possible equipment connections and collectors to the appliance in an example embodiment.

FIG. 7(b) shows different possible monitor communications with the appliance in an example embodiment.

FIG. 8 is a flow diagram illustrating an Auto Discovery process in an example embodiment.

FIG. 9 is a flow diagram illustrating a Network Monitoring process in an example embodiment.

FIG. 10 is a flow diagram illustrating an Alarm Management process in an example embodiment.

FIG. 11 is a flow diagram illustrating a Report Generation process in an example embodiment.

FIG. 12 shows a schematic drawing of a computer system for implementing a method in accordance with an example embodiment.

FIG. 13 is a flow diagram illustrating an method of managing a network in an example embodiment.

### DETAILED DESCRIPTION

The example embodiment described herein can provide a method for reducing the complexities of network management.

In an example embodiment, a network management software is designed and developed. This software can be embedded into a linux-based hardware appliance. There are no requirements for a monitor display, mouse or keyboard to be attached to the appliance. The network management appliance comes with a built-in web server and the users are able to access the network management functions using a web browser from any PC terminals. There are no client software requirements for these client PC terminals. The appliance, once connected to the network, will be able to auto-discover the network, systems and applications. It will then be able to automatically start managing these objects.

In the example embodiment, the appliance hardware is an intel-based architecture, with made-to-order components and chassis. It is installed with an operating system such as a Red Hat Linux OS (v9 or above) and NetGain System's in-house developed network management software as mentioned above. This intelligent appliance shall be known as “NetGain Enterprise Manager”. End users can attain benefits such as quick installation and setup of the appliance, cost savings on additional hardware and easy access to the appliance's functions from any PC terminals, anytime and anywhere. End users will thus no longer be worried about long deployment cycles, high complexities and high costs of network management projects.

The various features of the appliance in this example embodiment are further elaborated in the following.

NetGain Enterprise Manager Architecture

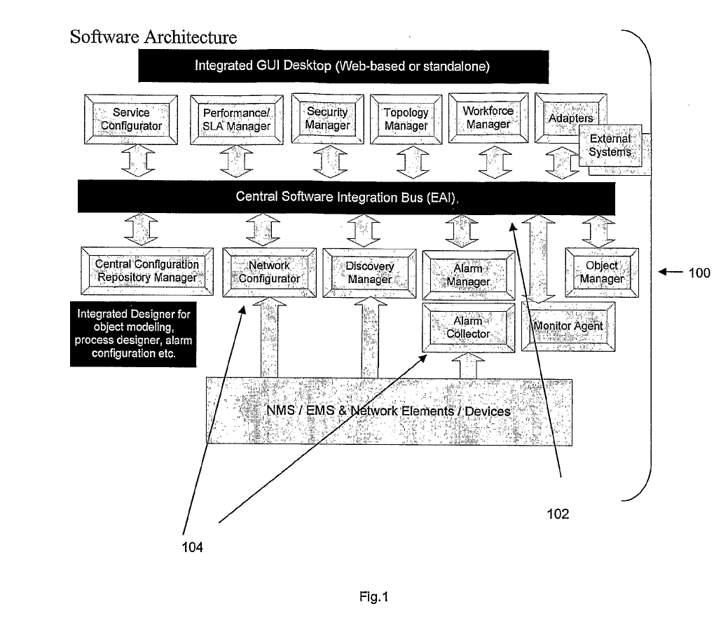

The architecture (100), as shown in FIG. 1, of the NetGain Enterprise Manager is based on carrier-class, component-based, highly scalable architecture. The system architecture (100) with a central software integration bus (102) makes it possible to have well integrated but loosely coupled software components (104) which are robust, independent and distributed in nature. The central software integration bus (102) allows additional, distributed and independent software components (104) to be easily ‘plugged-in’ to the system. The distributed design allows the scalability of the solution as the network expands and new services (104) are introduced.

Central Event Bus:

In order for additional components to be plugged in independently, a modular architecture where the components are loosely coupled but tightly integrated is required. Therefore, a system wide communication bus or a central event bus (102) is used to support a standard event format used by all the components (104) to communicate with each other as seen in FIG. 1. It provides a three-tier architecture to the entire system with the central event bus (102) decoupling the components while keeping them tightly integrated with the standard event format.

Linux-Based

In this example embodiment, there is a need for a secure and stable operating system, which does not degrade in performance over a considerable period of time. In order to fulfil this need, a subset of the Linux operating system was used as a base for this appliance. The software programs, such as seen in (104) in FIG. 1, that are part of the appliance start along with the operating system when the system is switched on. The entire system is externally connected through the LAN cable only. The system can be completely configured, monitored and managed through any web browser, such as Internet Explorer (IE).

Object-Modeling:

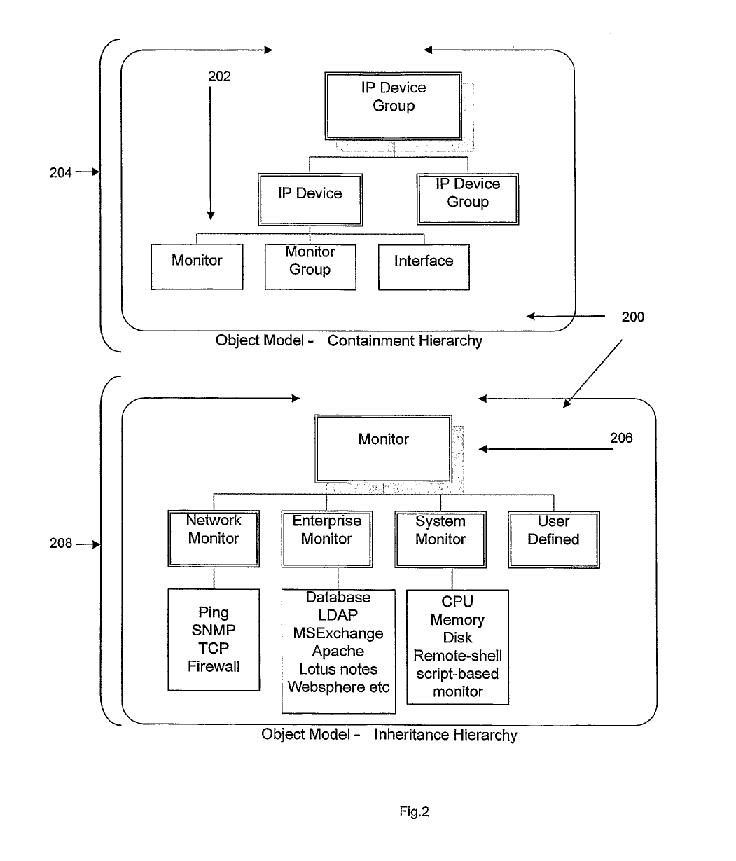

In this example embodiment, there is a need for the modelling of real world entities such as network elements like routers, PCs, servers, services, monitors etc so that their characteristics and behaviors can be faithfully replicated in software. As a result, XML-based object modeling was utilised to describe the relationships, hierarchy (200 in FIG. 2) and characteristics of the network elements. The Object modeling defines the containment of the defined objects as a containment hierarchy (204), such as IP Device Group may contain IP Device, which in turn may contain a Monitor (202). The inheritance hierarchy (208) definitions are defined from the most generic definition such as a Monitor (206) to more specific descriptions such as the CPU or Memory or Disk monitors, i.e. a specific definition extends a generic definition. Therefore, it is possible to define and introduce new technologies, as the newer definitions can inherit from earlier definitions.

Time-Series Based Performance DB:

To facilitate fast and easy access to monitoring and performance data collected from various network elements, services and applications, while using minimal amount of disk space, a time-series based performance database is implemented in the appliance. The performance counters and their values of monitor objects are stored as performance data records in performance data files within the folders named after the day they were collected. The transient performance counters are not saved in the database. The performance data being collected is kept in memory by the system until the data is saved to the file system, which is done periodically. Thus, the periodic saving of performance data collected by the system in memory will reduce the disk input/output time, which is the major performance bottle-neck in today's computer technology. The performance data files arranged as folders named by date will allow fast and easy access while generating and browsing historical and current performance data reports.

Multi-Threaded Architecture:

For high performance computing and faster response time, the system design is based on multi-threaded architecture. The architecture leads to higher performance, faster communication and sharing of process space and data.

Built-in Web Server:

In order to provide a fast and efficient web interface to the system, the web server runs within the same process space as other components in the system. This provides a fast and efficient interface as the process and data spaces are shared.

Central Repository & Designer:

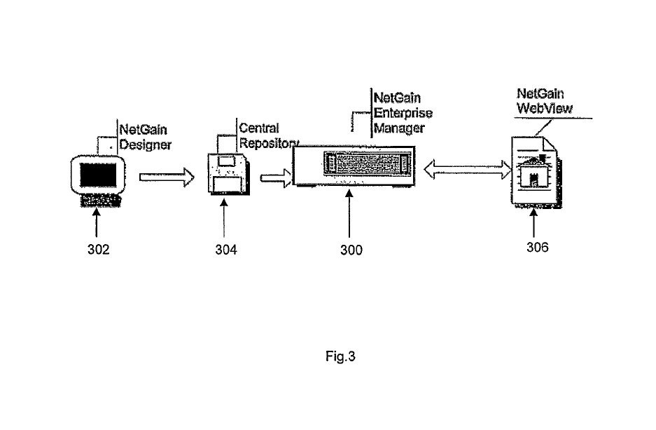

In order to consolidate and configure all the configurable parameters in the system (300) under one sub-application, the Designer (302) is used as seen in FIG. 3. The Designer (302) is a one-stop configuration utility for the whole system (300) while the sub-application is termed the ‘Central Repository’ (304). All the configurable parameters are arranged hierarchically as “resources”. A standard editor or a special editor can edit these resources through a web interface (306). The changes in the configuration are updated even while the system (300) is running. The total configuration information is saved in the ‘Central Repository’ (304).

Applet-Based Technology:

In order to eliminate the need to install the NetGain software in client PCs, a Web-based client (306) for the system (300), NetGain Enterprise Manager, is created. This client (306) provides an anytime, anywhere interface to configure, monitor and maintain the system through a standard web-browser. The applet based Desktop (306) can be run from the home page of the NetGain Enterprise Manager (300) device within a web-browser such as Internet Explorer. This provides the interface to start various other applications such as auto-discovery, network/service configurators, topology window, alarm viewer.

Agent-Based Technology:

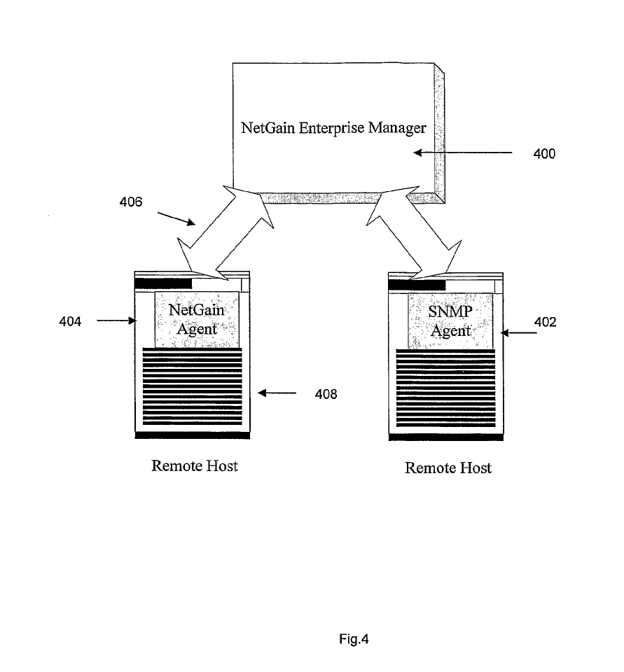

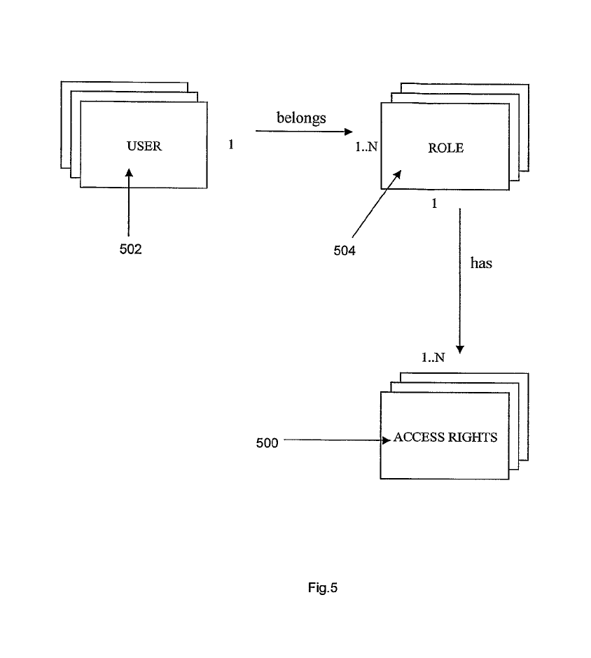

To provide monitoring data to the appliance (400) and scripting support for systems, services and applications that need more than what SNMP support (402) provides or those that lack SNMP support, an agent (404) can be installed as shown in FIG. 4. The agent can be installed and run on various operating systems such as Windows 98/2000/NT/XP, Linux, Solaris, HPUX, IBM-AIX etc. The agent is able to discover and provide monitoring support (406) for various types of services and applications. Additionally, it can provide scripting support in the native system's (408) scripting language. Thus, a high level of local control can be achieved over the monitored system with the installation of a lightweight agent (404).

Role-Based Security:

In order to provide multi-user access to the system based on access rights (500) and domain rights, an access system is set up where the access for users (502) to the system is based on the role (504) a user (502) belongs to. The role (504) of a user (502) contains the access rights (500) and the domain rights, such as allowed resources like a set of computers in a subnet. Once the user (502) is logged into the system, the interface and its components depend on the user's access rights (500) and domain rights. The various actions that are restricted will check for the access rights (500) of the user (502) if required. Thus, there is a centralised allocation of access rights (500) and domain rights to a role. Multiple users (502) can also share the same role.

Proactive Monitoring

Lightweight Monitors & Collectors

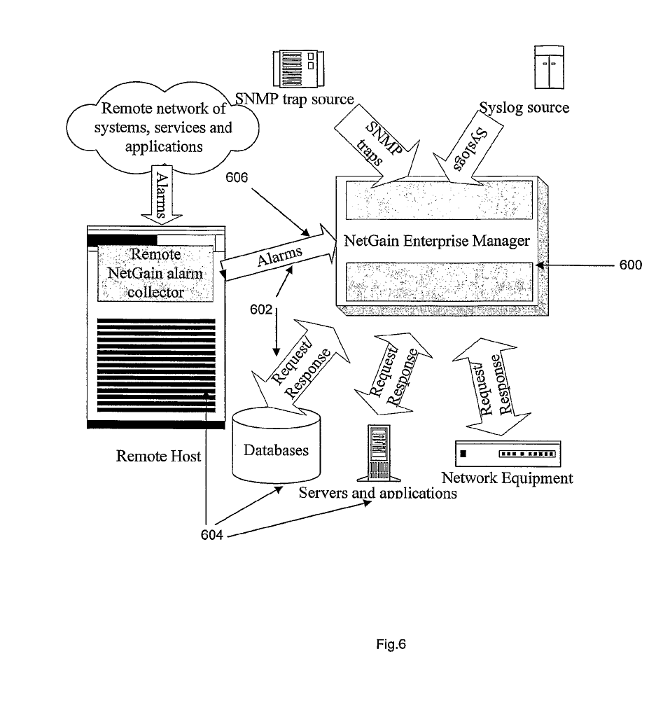

In this example embodiment, the appliance (600) can perform data collection for service level and performance monitoring such as shown in process (602) through a wide variety of lightweight monitors and collectors. The collectors and monitors collect fault and service level information from a wide range of devices, databases, logs and other sources (604) as can be seen in FIG. 6.

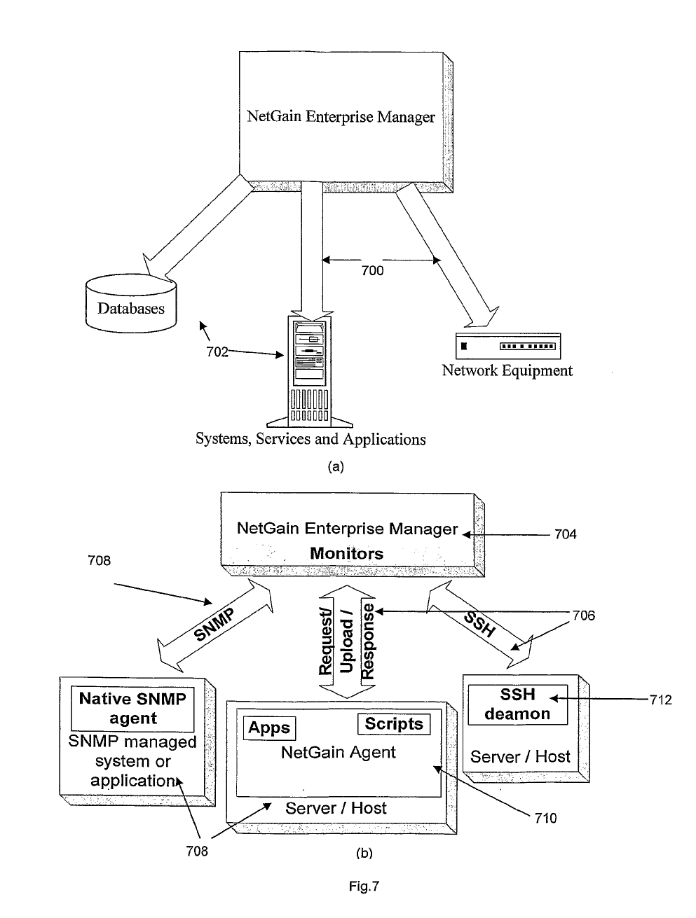

The collectors can be deployed virtually anywhere, allowing the collection of alarms (700) from remote sites and different locations (702) as shown in FIG. 7(a). The collectors enable unified alarm management by converting different types of alarms from disparate sources (702) such as SNMP Traps, Syslog etc into unified X.733 standard alarms, containing all the information provided by the native alarm.

The monitors (704) as shown in FIG. 7(b) pro-actively collect (706) performance and availability data from a wide range of managed environments (708) spanning across systems, services and applications, periodically and calculate the service, and if necessary trigger service level alarms on impending service disruptions.

A wide range of monitors (704) collect the necessary data using different methods. When using SNMP (708), the monitor requests necessary data from the native SNMP agents of the managed devices or applications, such as routers, databases, computers etc. When using the NetGain Agent (710), the necessary data can also be requested from lightweight NetGain agents (710) installed on remote servers/hosts. These agents (710) can be used to get specific or custom data such as application outputs, results of scripts etc, securely. The monitors can also use the secure shell method (712) to access the required data.

Management Scope

In this embodiment, the appliance NetGain Enterprise Manager helps to manage a wide range of environments and technologies, including network-based or internet-based devices and services, computing platforms, systems and servers, applications and services. For networks, management can be extended to network devices such as routers, switches, modems, etc. Management can also be extended to standard network services such as RADIUS, Ping, Remote Ping, DNS, DHCP, DayTime, FTP, TFTP, etc. Examples will be Network interfaces: availability, input/output error rate, input/output utilization, input/output discard rate, input/output error rate, input/output packet rate etc.

For systems, management can be extended to Unix-based hosts such as Linux, Sun, IBM-AIX, HP-UX. Examples are CPU utilization, Memory utilization, Disk utilization. Management can be extended to Windows servers and clients as well as database servers such as Oracle, Sybase, Informix, MS-SQL etc. Examples include Cache hit ratio, Transaction rate, Network read/write rate, User connections, Tablespace/database utilization etc. Management of systems can also be extended to firewalls, email servers such as MS Exchange etc., Application servers such as Apache Tomcat, Web Logic etc., middleware and Specific in-house applications.

Along with the out-of-the-box provided functionality and management scope, it is modular and flexible enough to extend to new technologies, services and applications, by introducing custom-made plug-in modules, when required.

Auto-Discovery and Monitoring:

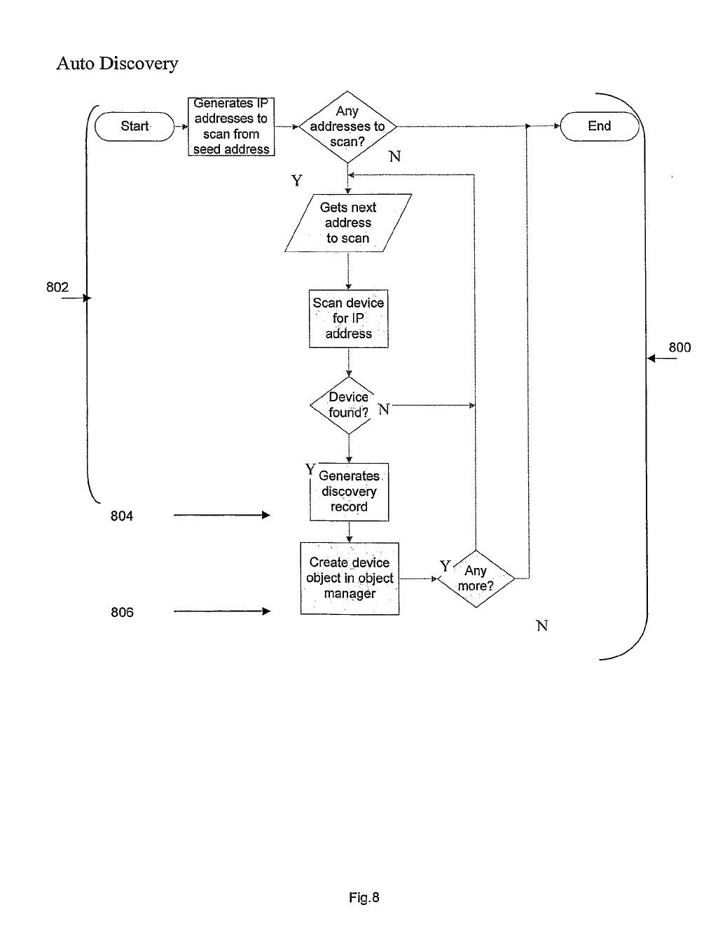

The example embodiment also provides a system to enable automatic discovery and monitoring of network elements such as systems, servers and the services and applications running on them. The auto-discovery process is shown in FIG. 8. The discovering (800) of network elements, services and applications running on them is carried out through multi-threaded discovery scanners using SNMP, Agent and other protocols. The multiple discovery scanners scan (802) the network for additional systems, services and applications to monitor and generate discovery records (804). At the same time in separate threads there are discovery handlers processing the newly created discovery records to create objects (806) for the monitors. Multi-threaded and pipe-line discovery enables the system to discover (800) network elements, services and applications faster. Modular architecture allows introducing future support for newer systems, services and applications.

Monitoring Architecture:

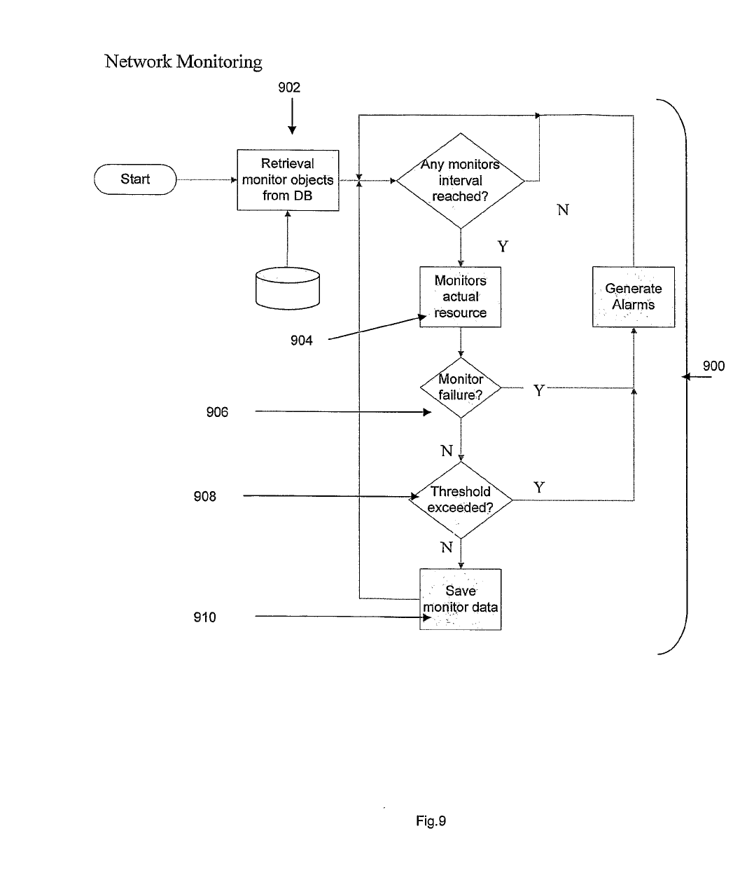

In order to support a large number of intelligent monitors while consuming minimal resources such as processor time, disk space and memory space, the monitoring architecture (900) as shown in FIG. 9 is based on a complex multi-threaded object-oriented design. This enables the performance of effective monitoring (900) while maximizing the supported number of monitors within the available resources such as cpu-time, disk and memory space. A monitoring agent is responsible for monitoring a set of devices, services and applications; it periodically distributes the actual monitoring load across a large number of monitor workers running in separate threads. These monitor workers create (902) the monitor from its description on-demand and execute (904) it to get the monitor results. The creation (902) of monitor on demand reduces the memory space required to support a large number of monitors. The monitor results are processed (906) by the monitor workers to detect failure or degradation of service based on specified service level criteria (908) and then saved (910) to the performance DB.

SLA Management

The IT infrastructure managers would need the systems, services and applications in an enterprise to perform at an acceptable level and provide the required functions or services at a perceived service level considered to be satisfactory. To quantify and measure the acceptable and satisfactory levels of service and performance would greatly enhance the IT manager's view of the health of their infrastructure as well as their customer's perception of their services. By getting to know the up-to-date system health and customer's experience of their services the IT managers can protect revenue and enhance customer satisfaction.

The Service Level Agreements or SLAs of systems, services and applications in the enterprise help to define the acceptable levels of availability, performance and service levels. The SLAs could be agreements between the enterprise and the customers or could be the expected behavior for disruption-free IT operations.

In this embodiment, NetGain monitors help to ensure the SLAs are being honored while reflecting the real-time performance and service level status of the device, service or application it is monitoring. A monitor's SLAs are defined by their monitoring parameters and service level criteria.

The parameters of a monitor include the status of monitoring, for example, enabled or disabled, the monitoring interval between two discrete measurements, the period of timeout for a discrete measurement to be considered a failure, the number of retry attempts to be made as well as any other parameters specific to the monitor, such as IP address or port number etc.

The service level criteria of a monitor specify the rules for unacceptable values of measured parameters and the Service level agreement (SLA) thresholds, such as SLA warning threshold and SLA violation threshold.

In this example embodiment, a monitor can measure multiple parameters for a single measurement. Under the service level criteria, the rules of unacceptable values of these parameters specify whether the measured set of parameter values is unacceptable. In the event where the parameter values are unacceptable, the single/discrete measurement is considered a failure.

Under the service level criteria, the SLA thresholds define the percentage of failed single/discrete measurements over a specified period of time. The status of service level of a monitor can be in good, SLA warning or SLA violation over a specified period of time, based on these thresholds. The following will be a good example of this feature. Consider a website URL monitor. The single parameter ‘Response time in milliseconds’ can be used in a rule, specifying the unacceptable values, such as: Response time greater than 10,000 milliseconds=unacceptable, if it is specified that 50% of failed measurements lead to service level violation over any specified time period and in a day if there are 48 measurements, once every half an hour, then if 24 measurements or more fail, then the monitor is in SLA violation status. Similarly, in an hour if there are 2 measurements, once every half an hour, then if 1 measurement or more fail, then the monitor is in SLA violation status.

Scripting Engine:

In order to specify actions in scripts that resemble a high-level programming language such as Java, to execute at specified points of customization, a scripting engine is created. This provides a highly customizable solution with an easily programmable framework where in certain points of customization, such as, creation of objects, propagation of an event etc., the behavior of the system can be further customized by allowing for programming the system to perform flexible tasks using the APIs provided by the system itself.

Event/Alarm Correlation Engine

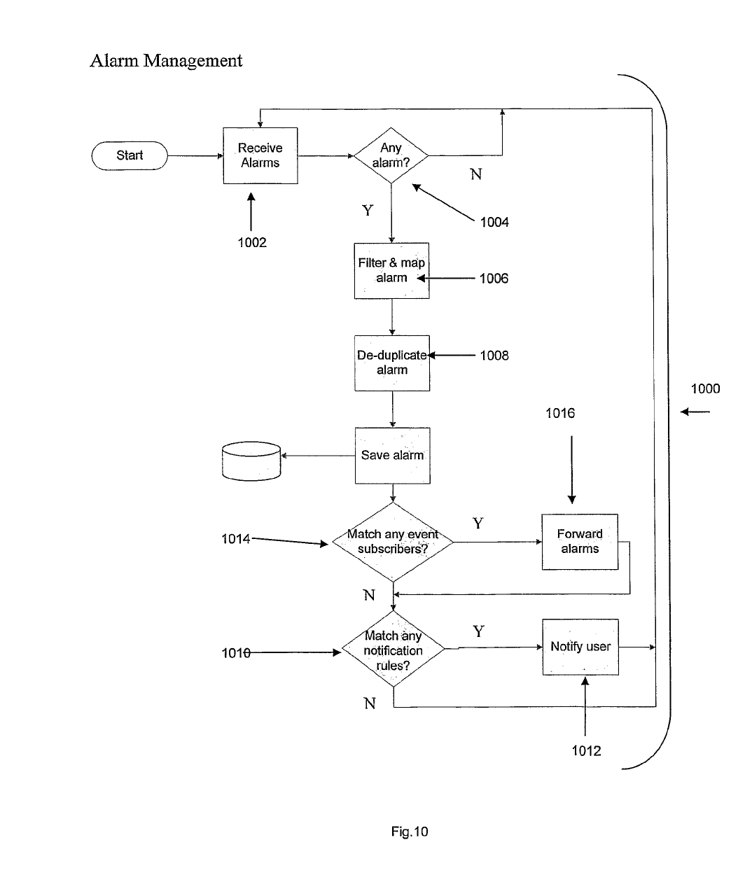

In this example embodiment, the appliance NetGain Enterprise Manager (600) provides unified management of alarms (606) from various disparate sources (604) such as devices, services and applications. The fault information in alarms are put through an intelligent set of correlation rules to suppress redundant information, isolate and quickly identify and resolve cause of the problem. The alarm management process (1000) is shown in FIG. 10.

The alarm correlation rules are applied to each alarm to be propagated with regards to other alarm information as specified in the rules. The supported correlation rules are alarm root cause rules, alarm threshold count rules and alarm transient correlation rules.

The alarm root cause rule defines the relation of a root cause object's alarm to the dependant object's alarm in a time window. Such rules can be defined for well-known dependencies, such as a web-server and a web-site. If a root cause alarm arrives (1002) prior to the dependant alarms, the dependant alarms are not propagated till the root cause is fixed within a time window. A check for other alarms is also carried out as shown in stage 1004. This behavior could help to quickly identify the root cause, while helping to focus away from the dependant alarms. The following is an example of this alarm. If a web-server is down the web-site would be down as well. Therefore if a root-cause alarm ‘web-server down’ is present within a reasonable amount of time prior to the arrival of ‘web-site down’ alarm, then the ‘web-site down’ alarm is not sent.

The alarm transient correlation rules are intended for a flood of alarms that notify a changing attribute, for instance state of a device. The final value of the attribute is considered (1006) while ignoring the transient values using this rule, over a specified time window. The following is an example of this alarm. If a state of a communication port changes very frequently, say every few micro-seconds, it could send a changing status signals as alarms. The transient rule helps to receive the final status during a given time window, say a second.

The alarm threshold count rule specifies the threshold value of the number of times a particular type of alarm should be allowed to propagate. This rule helps to suppress ‘alarm flood’ or repetitive alarms of the same type from the same source. The following is an example of this alarm. There could be a device or service such as a communication port which would send multiple similar alarms repeatedly every few micro-second on an existing error. The threshold count rule can help to de-duplicate (1008) the multiple alarms and present them as a single alarm if they arrive within a given time window, say a second.

Inventory Management

Effective IT infrastructure management practices need accurate physical inventory, due to the fact that knowing what is available is necessary to plan to manage and control the assets effectively. The asset management practice can only succeed if the underlying asset repository is accurate and it must be maintained and validated by periodic checks on the physical inventories or over time the repository will become inaccurate. Experience shows inaccurate asset repository can be worse than no repository since users can make important decisions based on very flawed data.

In this embodiment, the appliance NetGain Enterprise Manager (600) keeps track of the managed devices and related inventory, through a process of auto-discovery and inventory query. It helps to periodically check the physical and logical assets through communication processes (602) while being able to query and classify by their types and sub-types.

The auto-discovery process helps to populate the inventory database with up-to-date information on devices. Their attributes such as, the type of Operating System, other attributes, including SNMP attributes, services, devices installed on the host, processes running on the host and the software installed on the host are recorded in the inventory database.

The users can perform inventory queries based on the types and subtypes of resources (604) such as, network routers, network switches, network bridges, computers, performance monitors, Operating systems, protocol based devices, categories and the IP Address.

The types of resources may be further categorized and sub-categorized where necessary. The inventories queried are with details of the resource such as services, monitors and other related objects.

Automating Management Tasks

To increase business process efficiency, quickening the pace of information exchange and bridging the semi-automated and manual tasks becomes an utmost priority. For instance, routine IT infrastructure issues such as notifications could be automatically generated, assigned and sent to the responsible groups or individuals swiftly. The automation should be flexible enough to be adjusted and introduced into the system efficiently with minimal delay.

In this embodiment, the appliance NetGain Enterprise Manager (600) provides very flexible automation framework to trigger various tasks on incoming fault or service level information. It is a direct result of integration and sharing of real-time information in a common model across the components.

Notification

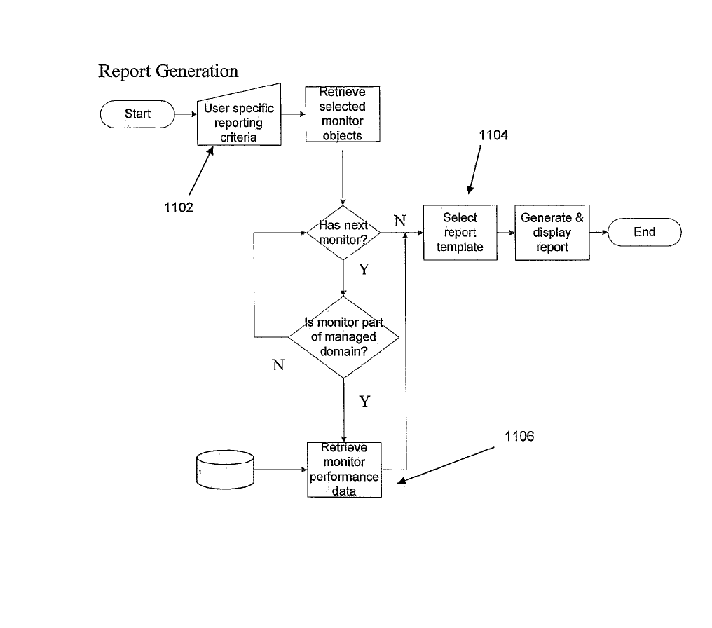

In this example embodiment, each user with a user account in the NetGain Enterprise Manager can create rules (1102) to specify various ways of notifying himself about creation or changes in the status of SLA, and alarms (900). Such notifications can be in different templates (1104) such as in the form of e-mails, SMS, popup-window or sound. The process of report generation from monitors can be seen in FIG. 11.

Notification Engine:

In the embodiment, the appliance is required to distribute notifications efficiently and reliably. Efficient and reliable notification of users is carried out by the central notification engine which processes the asynchronous requests. The central notification engine operates on a set of notification rules (1010) for each user. It receives notification causes such as alarms or service level changes. These notification causes are relayed (1012) to the users as specified by the notification rules (1010). The notification rules (1010) specify the description (1106) of the cause, such as type of an alarm or object that caused the alarm or service level change etc. The rule also specifies the type of notification such as email, SMS, sound or a pop-up window etc.

Auto-Action on Alarms

Auto-actions on alarms are configured to be executed when an alarm is generated in the system. The auto-actions that match the ‘Filtering Criteria’ will be invoked (1014) for each alarm generated. The different types of alarm auto-actions are the script auto-action where a specified script is executed and the acknowledge auto-action where the alarm is auto-acknowledged and assigned to a specified user (1016).

Advantages of Example Embodiment Over Other Appliances:

Integrated all-in-One Functionality

NetGain Enterprise Manager provides out-of-the-box integrated functionality spanning across inventory management, fault management, topology management, and performance and SLA management, using shared information and data model.

The integrated functionality enables faster and more efficient information sharing across the various functionalities which in-turn would make end-to-end automation affordable and immediate reality. Automation combined with faster and more efficient information sharing can help to meet the critical business goals such as to reduce cost, increase efficiency, reduce service time-to-market, accelerate time-to-revenue, ensure quality of service and guarantee customer satisfaction.

The cost to integrate products addressing different functionalities, such as inventory management, service level management, fault management etc., is eliminated. Even in the integration of best of breed products, the format differences, content duplication and mismatches in files or database entries create a significant bottle-neck in both performance and information-flow.

Quick Installation & Deployment

The network appliance concept enables NetGain Enterprise Manager to be rapidly deployed without any installation hassles and requirements. It can be mounted in a rack and hooked onto the LAN, while the users can login and perform their management tasks, including configuration through their favourite web browsers.

Typical turn-around period of deployment, installation and basic training such that users could perform basic management of their network, services and application could be expected to be a matter of a day or two.

Ease of Learning and Usage

The system is presented in an intuitive and user friendly manner, while the usage and user interface has been designed to have a very quick learning curve.

Traditionally complexity of usage means increase of cost for training as well as the need for trained man-power. While maintaining the simplicity of usage with a simpler facade to complex problems, NetGain Enterprise Manager provides a simple and easy solution for non-experts to manage the system at the level of a true expert.

The NetGain Enterprise Manager is a unique network appliance based enterprise management solution that offers out-of-the-box integrated management of network services and applications, with holistic support of the hardware and software areas of the solution. It provides a wide range of integrated functionality spanning service level management, topology management, alarm management and inventory management and helps to automate tasks with shared data and up-to-date information.

The modular and flexible architecture and central server concept helps the solution to meet the growing needs of the IT infrastructure by making upgrades and maintenance hassle-free. With its rapid deployment and ease of usage it promises faster return on investment, while keeping the cost low per managed system. The integrated end-to-end management of service delivery infrastructure would certainly help the enterprise towards achieving its business goals.

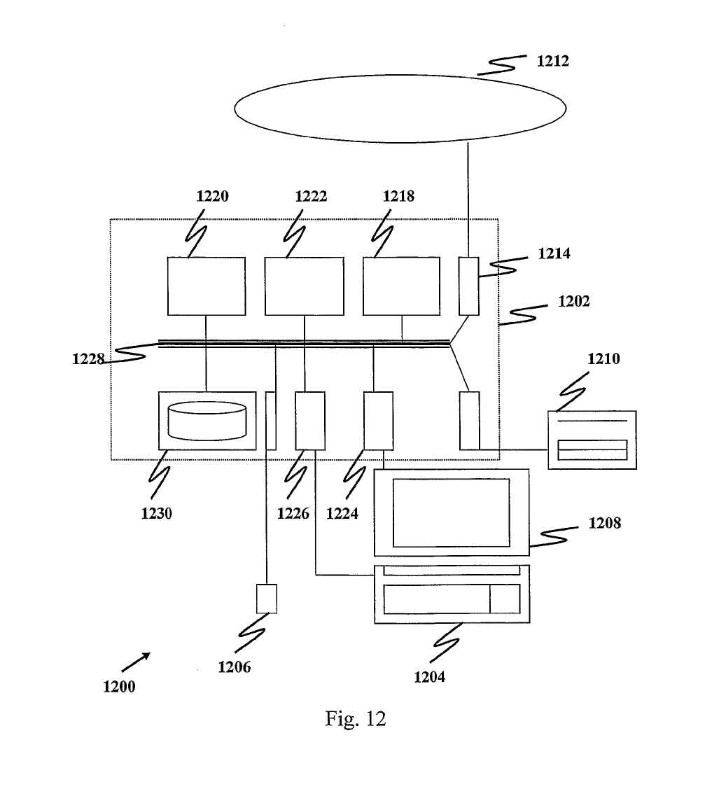

The method and system of the example embodiment can be implemented on a computer system (1200), schematically shown in FIG. 12. It may be implemented as software, such as a computer program being executed within the computer system (1200), and instructing the computer system (1200) to conduct the method of the example embodiment.

The computer system (1200) comprises a computer module (1202), input modules such as a keyboard (1204) and mouse (1206) and a plurality of output devices such as a display (1208), and printer (1210).

The computer module (1202) is connected to a computer network (1212) via a suitable transceiver device (1214), to enable access to e.g. the Internet or other network systems such as Local Area Network (LAN) or Wide Area Network (WAN).

The computer module (1202) in the example includes a processor (1218), a Random Access Memory (RAM) (1220) and a Read Only Memory (ROM) (1222). The computer module (1202) also includes a number of Input/Output (I/O) interfaces, for example I/O interface (1224) to the display (1208), and I/O interface (1226) to the keyboard (1204).

The components of the computer module (1202) typically communicate via an interconnected bus (1228) and in a manner known to the person skilled in the relevant art.

The application program is typically supplied to the user of the computer system (1200) encoded on a data storage medium such as a CD-ROM or floppy disk and read utilising a corresponding data storage medium drive of a data storage device (1230). The application program is read and controlled in its execution by the processor (1218). Intermediate storage of program data maybe accomplished using RAM (1220).

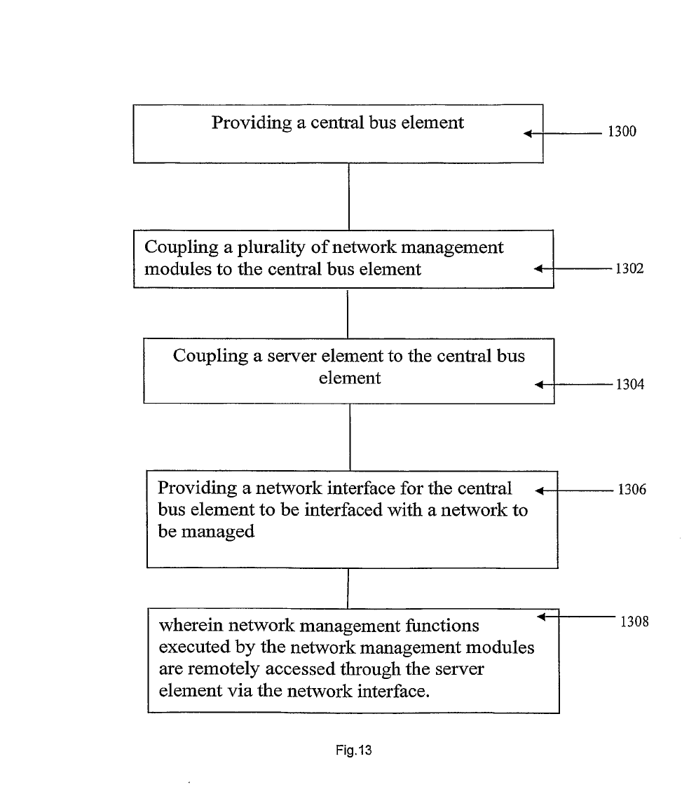

FIG. 13 shows a flowchart illustrating a method for managing a network in an example embodiment. At step 1300, a central bus element is provided. At step 1302, a plurality of network management modules are coupled to the central bus element. At step 1304, a server element is coupled to the central bus element. At step 1306, a network interface is provided for the central bus element to be interfaced with a network to be managed, and, at step 1308, network management functions executed by the network management modules are remotely accessed through the server element via the network interface.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A network management appliance for managing a network, comprising:
a software integration bus;
a plurality of network management modules coupled to and in data communication with the software integration bus, for managing a plurality of configurable network parameters and employing a standard event format to communicate with said software integration bus;
a server element coupled to and in data communication with the software integration bus; and
a network interface for interfacing the software integration bus with the network;
wherein said configurable network parameters are remotely monitorable and configurable through the server element via the network interface.

2. A network management appliance as claimed in claim 1, further comprising a performance database maintained by said appliance for storing performance data pertaining to elements of said network.

3. A network management appliance as claimed in claim 1, wherein the network management modules comprise two or more selected from a group comprising:
a configuration utility module;
an auto-discovery process module;
an alarm correlation engine module;
a role-based security utility module;
a module consisting of data monitors and collectors;
a Service Level Agreement (SLA) management processes module;
an inventory management utility module;
a notification engine module;
an automatic-actions on alarms utility module; and
a management tasks automation utility module.

4. A network management appliance as claimed in claim 3, wherein the configuration utility module is configured to consolidate and configure parameters for the network.

5. A network management appliance as claimed in claim 3, wherein the alarm correlation engine module has a set of alarm correlation rules and is configured to manage alarms from the network by reference to the set of alarm correlation rules.

6. A network management appliance as claimed in claim 3, wherein the role-based security utility module provides a centralized allocation of access and domain rights to network users based on their roles as recorded in an access system implemented in the role-based security utility module.

7. A network management appliance as claimed in claim 3, wherein the Service Level Agreement (SLA) management processes module has criteria for thresholds of service levels, and is configured to compare performance data against the criteria for thresholds of service levels and to decide on a next course of action.

8. A network management appliance as claimed in claim 3, wherein said inventory management utility module includes a user database query utility for retrieving inventory information of the network from the inventory management utility module.

9. A network management appliance as claimed in claim 3, wherein the notification engine module includes a set of notification rules and is configured to issue notifications based on the set of notification rules.

10. A network management appliance as claimed in claim 3, wherein the automatic-actions on alarms utility module includes filtering criteria and is configured to execute automatic actions according to matches between alarm events provided by the alarm correlation engine module and the filtering criteria.

11. A network management appliance as claimed in claim 3, further comprising a central data repository; wherein management data associated with the network management functions executed by the network management modules is stored in the central data repository.

12. A network management appliance as claimed in claim 3, wherein the server element comprises a web server for facilitating the monitoring and configuring of said configurable network parameters.

13. A network management appliance as claimed in claim 3, wherein the network management modules are remotely accessible by utilizing one or more selected from a group consisting of:
an object-modelling capability;
an agent-based technology;
an applet based technology; and
a scripting engine.

14. A network management appliance as claimed in claim 3, further comprising:
a plurality of performance counters; and
a file system for storing performance data;
wherein output from the plurality of performance counters is stored as performance data in the file system, and transient performance counters are not stored in the file system.

15. A network management appliance as claimed in claim 14, wherein the performance data is stored into the file system periodically.

16. A method for managing a network, the method comprising:
providing a software integration bus;
providing a plurality of network management modules in data communication with the software integration bus, for managing a plurality of configurable network parameters of said network and employing a standard event format to communicate with said software integration bus;
providing a server element in data communication with the software integration bus;
providing a network interface for the software integration bus to be interfaced with the network; and
providing the software integration bus, the network management modules, the server element and the network interface in a discrete appliance;
wherein said configurable network parameters are remotely monitorable and configurable through the server element via the network interface.

17. A computer readable data storage medium having stored thereon computer code for instructing a computer having a software integration bus, a server element and a network interface to execute a method for managing a network, the method comprising:
providing a plurality of network management modules;
facilitating data communication between said network management modules and the software integration bus;
facilitating management of a plurality of configurable network parameters of the network by the network management modules using a standard event format in communication between the network management modules and the software integration bus;
facilitating data communication between the server element and the software integration bus; and
facilitating interfacing by said network interface of the software integration bus and the network;
wherein said configurable network parameters are remotely monitorable and configurable through the server element via the network interface.
